(19) United States
(12) Patent Application Publication
(10) Pub. No.: US 2013/0011665 A1
(43) Pub. Date: Jan. 10, 2013

(54) HEAT CURABLE COMPOSITIONS FOR TINTABLE ABRASION RESISTANT TRANSPARENT HARD-COATINGS

(75) Inventors: Lixin Song, Charenton Le Pont (FR); Puat Wen Teo, Charenton Le Pont (FR)

(73) Assignee: ESSILOR INTERNATIONAL (COMPAGNIE GENERALE D' OPTIQUE), CHARENTON LE PONT (FR)

(21) Appl. No.: 13/634,669

(22) PCT Filed: Mar. 23, 2011
(86) PCT No.: PCT/EP2011/054451

§ 371 Date: Sep. 13, 2012

(30) Foreign Application Priority Data
Mar. 25, 2010 (EP) 10305301.3

(51) Int. Cl. C09D 163/00; G02C 7/02; G02B 1/04; C08K 5/5419; B05D 5/06

(52) U.S. Cl. 428/336; 523/466; 523/456; 427/164

(57) ABSTRACT

The present invention is relative to a heat-curable coating composition forming transparent tintable abrasion-resistant coatings, said compositions comprising, in an aqueous or hydro-organic solvent:
(A) a hydrolysate of an epoxy-functional silane compound containing at least two alkoxy groups,
(B) colloidal silica having an average particle diameter of 1 to 100 μm,
(C) an aluminium chelate compound of formula

Al(O—C₁₋₄ alkyl)ₙY₃₋ₙ
wherein n is 0, 1 or 2 and Y is a ligand selected from the group consisting of
M-C(═O)—CH₂—C(═O)-M and
M-C(═O)—CH₂—C(═O)O-M,
wheren each M is independently a C₁₋₄ alkyl group, and
(D) a hydrolysate of a silylated poly(tetrahydrofurane) of formula (Ia) or (Ib)

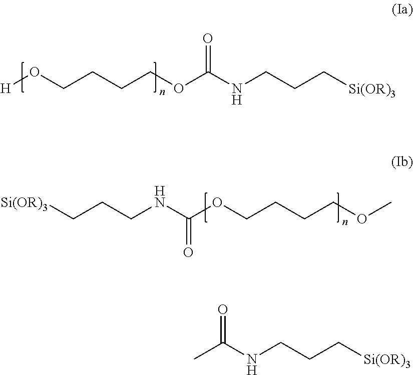

said heat-curable composition not containing any multifunctional cross-linking agents selected from the group consisting of multifunctional carboxylic acids and multifunctional anhydrides.

The present invention relates to heat-curable silane-based coating compositions, to transparent tintable hard-coatings obtained therefrom, and to optical articles, in particular ophthalmic lenses, containing such hard-coatings.

Ophthalmic lenses of transparent organic material (organic glass) are lighter and less brittle than mineral glass and are now widely used. One of the main inconveniences of organic glass is its far lower resistance to scratching and abrasion. Ophthalmic lenses made of thermoplastic or thermosetting polymers are therefore generally protected by applying a thermocurable or photocurable coating composition, for example based on alkoxysilanes and silica, and polymerising the alkoxysilanes in the presence of suitable catalysts.

When such organic glasses are made of non-tintable materials, such as thermoplastic polycarbonates, the hard-coating should further be easily tintable by immersion in a dying bath.

Most of the prior art tintable hard-coatings are however still lacking abrasion resistance when compared to mineral glass.

U.S. Pat. No. 5,013,608 for example discloses tintable, abrasion resistant coating compositions based on colloidal silica, epoxyfunctional alkoxysilanes, multifunctional crosslinking agents and selected tintability enhancing agents.

Although the coating compositions described in these prior art documents, such as the product TC 332 sold by SDC, have a rather satisfactory tintability, their ISTM Bayer abrasion resistance unfortunately does not exceed about 1-1.3.

The Applicant now has developed particular epoxy-functional alkoxysilane-based coating compositions which have both excellent tintability and ISTM Bayer abrasion resistance significantly higher than the known compositions. The coating compositions of the present invention, unlike the ones disclosed in the above references, are free of any multifunctional cross-linking agent for the epoxy groups. They further use a tintability enhancing compound which is copolymerizable with the other ingredients of the composition and which up to now has never been used for the same purpose.

The present invention is drawn to a heat-curable coating composition which, upon curing, forms a transparent tintable abrasion-resistant coating, said heat-curable coating composition comprising, in an aqueous or hydro-organic solvent, the following components (A) to (D):

(A) a hydrolysate of an epoxy-functional silane compound containing at least two alkoxy groups,

(B) colloidal silica having an average particle diameter of 1 to 100 μm,

(C) an aluminium chelate compound of formula

Al(O—C₁₄ alkyl)ₙY₃₋ₙ

wherein n is 0, 1 or 2 and Y is a ligand selected from the group consisting of

M-C(═O)—CH₂—C(═O)-M and

M-C(═O)—CH₂—C(═O)O-M,

wherein each M is independently a C₁₋₄ alkyl group, and

(D) a hydrolysate of a silylated poly(tetrahydrofurane) of formula (Ia) or (Ib)

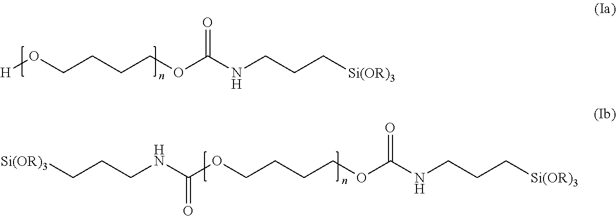

wherein n is an integer selected from 10 to 20 and each R is independently a C₁₋₅ alkyl group, preferably a methyl or ethyl group, or a C₁₋₅ acyl group,
said heat-curable composition not containing any multifunctional cross-linking agents selected from the group consisting of multifunctional carboxylic acids and multifunctional anhydrides.

The present invention is also drawn to a method for forming an abrasion-resistant hard-coating on a transparent substrate, preferably on a transparent organic substrate, and to an optical article obtained by such a method, said article comprising a clear, insoluble hard-coating resulting from the curing of the above heat-curable composition.

The first ingredient (Component (A)) of the composition is a hydrolysate of an epoxy-functional silane compound containing at least two alkoxy groups. The epoxy bearing group should not be cleavable from the Si atom during the hydrolysis/polymerisation reaction and is preferably bonded to the central Si atom of the alkoxysilane via a Si—C bond. Said epoxy group may be a glycidyl group or an epoxy group on a cycloalkyl residu, such as 3,4-epoxycyclohexyl. It is preferably a glycidyl group.

The alkyl moiety of the at least two alkoxy groups is a lower alkyl having from 1 to 6, preferably from 1 to 4 carbon atoms. Most preferred alkoxy groups are methoxy and ethoxy.

In a preferred embodiment, the hydrolysate of an epoxy-functional silane compound is selected from a hydrolysate of a silane compound containing three alkoxy groups directly bonded to the silicon atom and one epoxy-functional group bonded to the silicon atom via a Si—C bond. Said epoxy-functional silane compound has advantageously the following formula

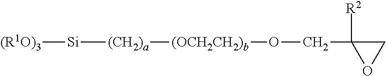

wherein each R¹ is independently a C₁₄ alkyl group, preferably a methyl or ethyl group, R² is a methyl group or hydrogen atom, a is an integer of from 1 to 6, and b is 0, 1 or 2.

The most preferred epoxy-functional silane compound for the purpose of the present invention is γ-glycidoxypropyltrimethoxysilane.

Component (A) is present in the heat-curable coating compositions in an amount of from 5 to 25% by weight, preferably of from 10 to 20% by weight, relative to the total uncured composition.

The amount of component (A) can further be defined by means of the (A)/(B) weight ratio which is advantageously comprised between 0.1 and 1, preferably between 0.2 and 0.8 and most preferably between 0.25 and 0.5.

Component (B) is essential for providing the final cured coatings with good hardness and abrasion resistance. However when its proportion in the final hard coating is too high, the resulting coating becomes less abrasion resistant. Component (A) when used without component (B) leads to hard but brittle coatings. Addition of colloidal silica provides flexibility and thereby better abrasion resistance. However when the colloid content is too high, the coating's adhesion to the underlying support will become poor. The amount of colloidal silica in the heat-curable coating composition of the present invention advantageously ranges from 10 to 30% by weight, preferably from 15 to 25% by weight, relative to the total weight of the composition (including the solvent phase). The amount of colloidal silica expressed relative to the total solids content of the composition is comprised between about 40% and 60%, more preferably between 45 and 55%.

If desirable for the purpose of increasing the refractive index of the final hard coating, up to 20% of the colloidal silica forming Component (B) may be replaced by one or more colloidal metal oxides selected, for example, from the group consisting of titania, zirconia, tin oxide, animony oxide, iron oxide, lead oxide, and bismuth oxide.

Component (C) catalyzes the condensation reaction between the silanol groups of Components (A), (B), (D), and (E) if present, during the heating step of the preparation method. It should be present in an amount ranging from 0.2 to 2% by weight, preferably from 0.5 to 1.5% by weight, relative to the total weight of the heat-curable composition. Exemplary Components (C) include aluminum acetylacetonate, aluminum ethylacetoacetate, aluminum ethylacetoacetate bisacetylacetonate, aluminum di-n-bisethylacetoacetate, aluminum di-butoxide monoethylacetoacetate, aluminum di-iso-propoxide monomethylacetoacetate, or mixtures thereof.

Component (D) is responsible for good tintability of the resulting hard coat. The higher its concentration in the coating composition and in the final cured coating, the easier the coated optical articles are tinted with hydrophilic dyes. However, at too high concentrations of Component (D) the resulting hard coatings suffer from insufficient abrasion resistance.

The Applicant has noted that the use of coating compositions containing from 2 to about 20%, preferably 4 to 18% and even more preferably 5 to 15% % by weight of Component (D) leads to hard coatings having both good tintability and excellent abrasion and scratch resistance. The amount of Component (D) expressed relative to the total solids content of the composition should be comprised between about 4% and 40% by weight, more preferably between 10 and 30% by weight.

Component (D) is a polytetrahydrofurane polymer (PTHF) end-capped with silylated groups via urethane linkages. It may be prepared by reacting hydroxyl terminated polytetrahydrofurne with γ-isocyanatopropyltrialkoxysilane. The weight average molecular weight of the starting PTHF is advantageously comprised between 150 and 2000, preferably between 200 and 1200. For a given content of Component (D), the higher the molecular mass of the PTHF, the better the tintability of the resulting hard coat. However, the abrasion resistance of the coatings slightly decreases as a function of molecular weight of the silylated PTHF.

Component (D) is preferably a hydrolysate of a compound of formula (Ib) having both ends capped with silane groups. Compounds of formula (Ia) or (Ib) are known as such (CAS 288307-42-6 and CAS 144126-55-6 for the di-silylated PTHF, CAS 131744-23-5 for the mono-silylated PTHF). To the Applicant's best knowledge, they have never been used in silane-based transparent hard-coatings.

The heat-curable coating composition of the present invention may further comprise an additional Component (E), said component being a difunctional silane comprising only two polymerisable silanol groups. Component (E) is selected from at least one hydrolysate of a silane compound of formula SiT₂Z₂ where each T is an organic group which, upon hydrolysis, gives a silanol group, preferably a C₁₋₁₀ alkoxy group, and each Z is an organic group non reactive with regard to the components of the composition, bonded to the silicon atom via a Si—C bond, preferably a C₁₋₁₀ alkyl group or a C₆₋₁₀ aryl group.

Dimethyldimethoxysilane, dimethyldiethoxysilane and methylphenyldimethoxysilane are exemplary silane compounds of formula SiT₂Z₂. When present, Component (E) is preferably used in an amount ranging from 1 to 10% by weight relative to the total coating composition. The amount of component (E) expressed relative to the total solids content of the composition should be comprised between about 2 and 20% by weight.

The above ingredients are dispersed or dissolved in an aqueous or hydro-organic solvent phase. Said solvent phase contains at least 1 weight %, preferably at least 2 weight % of water. The water may result from the starting condensation reaction of the silanols formed during the hydrolysis. It may also be added together with each of the ingredients of the composition, in particular with hydrolysates (A) and (D). The presence of water is essential to guarantee good storage stability of the coating composition and to prevent early and undesirable viscosity increase of the composition before application to the substrate.

The organic fraction of the solvent phase is a water-miscible solvent having preferably a boiling point at atmospheric pressure of between 70° C. and 140° C. so that it may evaporate easily during the curing step. Suitable organic solvents are selected for example from the group consisting of methanol, ethanol, isopropanol, ethyl acetate, methylethylketone or tetrahydropyrane.

The compositions can further include various additives, such as surfactants, to improve spreading of the composition over the surface to be coated, or UV absorbers. The coating composition of the present invention should have a total solids content comprised between 30 and 70% by weight, preferably between 40 and 60% by weight.

The coating compositions of the present invention are prepared by
hydrolysing the epoxy-functional silane compound containing at least two alkoxy groups (component (A)), the compounds of formula (Ia) and/or (Ib) (component (D)), and the compound of formula SiT₂Z₂ (component (E)), if present, and
mixing said hydrolysates with a suspension of colloid silica (component (B)) and the curing catalyst (component (C)).

Hydrolysis of components (A), (D) and (E) may be carried out simultaneously or successively in a single container or separately. The mixing order of the different components is not critical for the present invention, though the curing catalyst is preferably added after mixing of the other ingredients. The final coating compositions are then stored at low temperature, preferably at less than 10° C., and heated to room temperature shortly before coating.

Optical articles having an abrasion-resistant tintable hard-coating are prepared by a method comprising the following successive steps of

(i) coating a transparent organic polymer substrate with a thin layer of a heat-curable composition containing components (A) to (D), and optionally (E), such as described above,

(ii) heating the substrate coated with the heat-curable composition to a temperature of at least 70° C., preferably of 75° C. to 90° C., for at least 5 minutes, preferably for 10 to 20 minutes, so as to form a tack-free coating,

(iii) heating the optical article with the tack-free coating to a temperature of at least 95° C., preferably of 100 to 110° C., for at least two hours, preferably for 2.5 to 3.5 hours, so as to obtain an optical article with a completely cured insoluble hard-coating.

The coating step may be carried out using any suitable coating technique. The coating compositions are preferably applied by dip-coating or spin coating.

The polymer substrate and the final optical article are preferably optical lenses and even more preferably ophthalmic lenses.

The final hard-coatings preferably have a thickness of from 2.9 to 6.5 μm, more preferably of from 4 to 5 μm.

### EXAMPLE

Preparation of Curable Coating Compositions

Formulation A and B according to the present invention (see below Table 1) are prepared as follows :
γ-glycidoxypropyltriethoxysilane (GLYMO) is weighed in a bottle,
an aqueous solution of HCl (0.1 N) is added dropwise under stirring, and the resulting mixture is left at room temperature under stirring for about 30 minutes for hydrolysis,
dimethyldiethoxysilane (DMDES) is added dropwise, followed by addition of the tinting additive of formula (Ib) obtained by end capping PTHF having a molecular weight of 250 with 3-isocyanatopropyltriethoxysilane (IPTEOS),
a 30 wt % suspension of colloidal silica in methanol is added and the mixture is allowed to stir for about 10 minutes,
after addition of a fluorinated surfactant (FC430, 3M Speciality Chemicals) dissolved in methyl ethyl ketone and curing catalyst (aluminum acetylacetonate), the mixture is stirred for 24 hours,
the final composition is cooled and stored at 4° C.

TABLE 1

| | Formulation | Formulation | Formulation C |
|---|---|---|---|
| ingredient | A | B | (comparative) |
| GLYMO (component A) | 16.74 | 15.81 | 18.60 |
| 0.1N HCl | 5.96 | 5.63 | 6.62 |
| DMDES (component E) | 8.76 | 8.27 | 9.73 |
| Aluminum acetylacetonate | 1.08 | 1.02 | 1.2 |
| (component C) | | | |
| Methyl ethyl ketone | 3.29 | 3.10 | 3.65 |
| FC 430 surfactant | 0.09 | 0.09 | 0.09 |
| SiO₂ colloid in methanol | 54.09 | 51.09 | 60.1 |
| (component B) | | | |
| IPTEOS end-capped PTHF | 10.00 | 15.00 | — |
| (component D) | | | |
| Total | 100 | 100 | 100 |
| Total solids content | 52.8 | 55 | 48 |

Coating and Curing

Formulations A, B and C containing respectively 10%, 15% and 0% of tint additive (component (D)), were then used, after conditioning to room temperature, for coating CR-39 lens substrates.

Before coating, the substrates were submitted to an adhesion-promoting surface treatment by immersion for 5-10 minutes in an aqueous solution of 3-aminopropyltriethoxysilane (5 wt %) and exposure to ultrasound. After rinsing with deionized water and drying (5 minutes at 75° C.) the lenses were cooled to room temperature.

The coating compositions according to the present invention (formulations A and B of Table 1) as well as two comparative formulations (Formulation C of Table 1 and the product TC 322 marketed by SDC) were applied by spin-coating to the surface-treated lenses in an amount sufficient for a cured coating thickness of about 3-6 μm.

The coated lenses were first heated for 15 minutes at 75° C. so as to form a tack-free coating, followed by post-curing for 3 hours at 105° C.

Assessment of Tintability and Abrasion Resistance

Tintability: BPI Black was used as a dye to evaluate the tintability of the coatings. BPI Black was mixed at volume ratio of 1:10 with water and stirred for several minutes to get a homogenous solution. Said dye solution was heated to 91° C. and maintained at this temperature for 30 minutes. The coated lenses and an uncoated CR-39 lens (thermoset poly(diethylene glycol bis-allylcarbonate)) were immersed together in the heated dye solution using a lens holder. When the transmission of the uncoated CR-39 lens reached 20% (normally after about 8 minutes), all lenses were taken out, rinsed with deionized water, dried and assessed for transmission. The transmission data at the second line of Table 2 (20% T Transmittance (%)) correspond to the transmittance of the coated lenses attained when the transmittance of the uncoated CR-39 lens was 20%. Low 20% T Transmittance values are indicative of a good tintability. The transmittance data at the third line of Table 2 have been measured on the coated lenses before the dying step.

Abrasion Resistance:

Abrasion resistance was assessed by the BAYER test carried out according to ISTM 06-002. A high BAYER value is indicative of a high abrasion resistance.

Coating adherence: The coating adherence of the coatings before and after dying was tested according to ISTM 02-010.

The coatings were cut with a cutter made of six blades into a crosshatched grid, adhesive tapes were then applied to the cut coating and were torn off perpendicularly to the surface, with a sharp, rapid, even and continuous movement towards the lens centre. Tests were carried out on five samples which were then sent for assessment.

TABLE 2

| | Coatings according | | | |
|---|---|---|---|---|
| | to the invention | | Comparative coatings | |
| | Formulation | Formulation | Formulation | TC |
| | A | B | C | 332 |
| tint additive | 10% | 15% | 0% | |
| concentration | | | | |
| 20% T transmittance | 64% | 54% | 73% | 58% |
| Transmittance | 89% | 90% | 93.3% | 91.5% |
| before dying | | | | |
| ISTM Bayer | 1.7 | 1.9 | 2.9 | 0.95 |
| Adhesion of non | 0 | 0 | 0 | 0 |
| tinted coatings | | | | |
| (Class) | | | | |
| Adhesion of tinted | 0 | 0 | 0 | 0 |
| coatings (Class) | | | | |
| Thickness of cured | 5 | 6 | 3.5 | 5 |
| hardcoat (μm) | | | | |

The above data clearly demonstrate that the coating compositions of the present invention lead to hard-coatings having both a satisfying tintability (20% T transmittance) equivalent to prior art compositions, and a better abrasion resistance (1.7 and 1.9 compared to 0.95).

1. Heat-curable coating composition which, upon curing, forms a transparent tintable abrasion-resistant coating, said heat-curable coating composition comprising, in an aqueous or hydro-organic solvent:
a hydrolysate of an epoxy-functional silane compound containing at least two alkoxy groups,
colloidal silica having an average particle diameter of 1 to 100 μm,
an aluminium chelate compound of formula
Al(O—C₁₋₄ alkyl)ₙY₃₋ₙ
wherein n is 0, 1 or 2 and Y is a ligand selected from the group consisting of
M-C(═O)—CH₂—C(═O)-M and
M-C(═O)—CH₂—C(═O)O-M,
wherein each M is independently a C₁₋₄ alkyl group, and
a hydrolysate of a silylated poly(tetrahydrofurane) of formula (Ia) or (Ib) 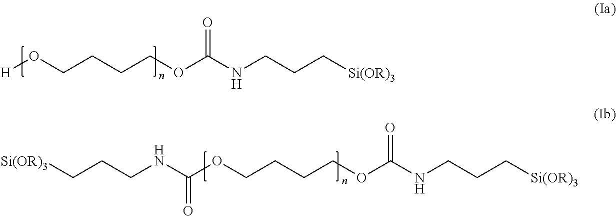
wherein n is an integer selected from 10 to 20 and each R is independently a C₁₋₅ alkyl group, or a C₁₋₅ acyl group
said heat-curable composition not containing any multifunctional cross-linking agents selected from the group consisting of multifunctional carboxylic acids and multifunctional anhydrides.

2. Heat-curable coating composition according to claim 1, wherein the hydrolysate of an epoxy-functional silane compound is selected from a hydrolysate of a silane compound containing three alkoxy groups directly bonded to the silicon atom and one epoxy-functional group bonded to the silicon atom via a Si—C bond.

3. Heat-curable coating composition according to claim 2, wherein the epoxy-functional silane compound has the following formula 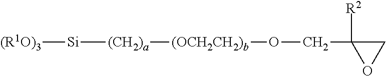
wherein each R¹ is independently a C₁₋₄ alkyl group, preferably a methyl or ethyl group, R² is a methyl group or hydrogen atom, a is an integer from 1 to 6, and b is 0, 1 or 2.

4. Heat-curable coating composition according to claim 3, wherein the epoxy-functional silane compound is γ-glycidoxypropyltrimethoxysilane.

5. Heat-curable coating composition according to claim 1, further containing (E) at least one hydrolysate of a silane compound of formula SiT₂Z₂ where each T is an organic group which, upon hydrolysis, gives a silanol group, and each Z is an organic group non reactive with regard to the components of the composition, bonded to the silicon atom via a Si—C bond.

6. Heat-curable coating composition according to claim 5, wherein the silane compound of formula SiT₂Z₂ is selected from the group consisting of dimethyldimethoxysilane, dimethyldiethoxysilane and methylphenyldimethoxysilane.

7. Heat-curable coating composition according to claim 1, wherein the following proportions by weight of the components (A), (B), (C), (D) and (E) based on the total weight of composition are:
5 to 25% parts of (A)
10 to 30% of (B)
0.2 to 2% of (C)
2 to 20% of (D),
optionally 1 to 10% of (E).

8. Composition according to claim 1, said composition containing at least 1% by weight of water.

9. Composition according to claim 1, wherein the total solids content of the composition is from 30 to 70% by weight.

10. Composition according to claim 1, wherein the silica component (B) comprises from 40 to 60% by weight of the total solids of the composition.

11. A method for forming an abrasion-resistant hard-coating on a transparent substrate, said method comprising the successive steps of
coating a transparent organic polymer substrate with a thin layer of a heat-curable composition such as defined in claim 1,
heating the coated substrate with the heat-curable composition to a temperature of at least 70° C., for at least 5 minutes, so as to form a tack-free coating,
heating the optical article with the tack-free coating to a temperature of at least 95° C., for at least two hours, preferably for 2.5 to 3.5 hours, so as to obtain an optical article with a completely cured insoluble hard-coating.

12. The method according to claim 11, wherein, in step (i), the substrate is coated with the heat-curable composition by spin coating or dip coating.

13. An optical article comprising a clear, insoluble hard-coating resulting from the heat-curing of a heat-curable composition according to claim 1.

14. The optical article according to claim 1, wherein the final hard-coating has a thickness of from 2.9 to 6.5 μm.

15. The optical article according to claim 13, said article being an ophthalmic lens.
